(19) United States
(12) Patent Application Publication
(10) Pub. No.: US 2026/0279256 A1
(43) Pub. Date: Sep. 17, 2026

(54) PIXEL AND ELECTRONIC DEVICE

(71) Applicant: Samsung Display Co., Ltd., Yongin-si (KR)

(72) Inventors: MINDO HEO, Yongin-si (KR); HYUNJOON KIM, Yongin-si (KR); YOUNGWAN SEO, Yongin-si (KR); JUNGHWAN HWANG, Yongin-si (KR); DANWON LIM, Yongin-si (KR)

(21) Appl. No.: 19/397,470

(22) Filed: Nov. 21, 2025

(30) Foreign Application Priority Data
Mar. 13, 2025 (KR) 10-2025-0032503

(51) Int. Cl. G09G 3/32

(52) U.S. Cl. CPC G09G 3/32; G09G 2300/0819; G09G 2310/08

(57) ABSTRACT

A pixel includes: a light emitting element connected between a first voltage line and a first node; a first transistor connected between the first node and a second voltage line and including a gate electrode connected to a second node; a first capacitor connected between the second node and a third node; a second transistor connected between a data line and the third node; a third transistor connected between the first node and the second node; and a fourth transistor connected between the second node and a third voltage line.

### CROSS-REFERENCE TO RELATED APPLICATIONS

The present application claims priority to and the benefit of Korean Patent Application No. 10-2025-0032503, filed on Mar. 13, 2025, in the Korean Intellectual Property Office, the entire disclosure of which is incorporated herein by reference.

### BACKGROUND

Aspects of some embodiments of the present disclosure described herein relate to an electronic device displaying an image.

Electronic devices such as televisions, mobile phones, tablet computers, navigation systems, and game consoles generate images and display the generated images to users through display screens.

The electronic device includes a plurality of pixels and driving circuits that control an image to be displayed on the plurality of pixels. Each of the plurality of pixels includes a light emitting element and transistors that control the light emitting element.

The above information disclosed in this Background section is only for enhancement of understanding of the background and therefore the information discussed in this Background section does not necessarily constitute prior art.

### SUMMARY

Aspects of some embodiments of the present disclosure include a pixel including a minimum number of elements and an electronic device including the same.

According to some embodiments of the present disclosure, a pixel includes a light emitting element connected between a first voltage line and a first node, a first transistor connected between the first node and a second voltage line and including a gate electrode connected to a second node, a first capacitor connected between the second node and a third node, a second transistor connected between a data line and the third node, a third transistor connected between the first node and the second node, and a fourth transistor connected between the second node and a third voltage line.

According to some embodiments, the second transistor may include a gate electrode connected to a third scan line, the third transistor may include a gate electrode connected to a second scan line, and the fourth transistor may include a gate electrode connected to a first scan line.

According to some embodiments, the first, second, and third scan lines may transfer first, second, and third scan signals, respectively.

According to some embodiments, one frame may include first, second, third, and fourth periods for emitting light of the light emitting element.

According to some embodiments, in the first period, each of the first, second and third scan signals may be at an active level, and the data line may transfer a reference voltage.

According to some embodiments, in the second period, the first scan signal may be at an inactive level, and each of the second and third scan signals may be at an active level, the data line may transfer a reference voltage, and the first voltage line may transfer a first driving voltage of a first voltage level.

According to some embodiments, in the third period, each of the first and second scan signals may be at an inactive level, and the third scan signal may be at an active level, the data line may transfer a data signal, and the first voltage line may transfer a first driving voltage of a first voltage level.

According to some embodiments, in the fourth period, each of the first, second and third scan signals may be at an inactive level, and the first voltage line may transfer the first driving voltage of a second voltage level different from the first voltage level.

According to some embodiments, the second voltage level may be greater than the first voltage level.

According to some embodiments, the pixel may further include a second capacitor connected between the third node and the second voltage line.

According to some embodiments of the present disclosure, a pixel includes a light emitting element connected between a first voltage line and a first node, a first transistor connected between the first node and a second voltage line and including a gate electrode connected to a second node, a first capacitor connected between the second node and a third node, a second transistor connected between a data line and the third node and connected to a third scan line, a third transistor connected between the first node and the second node and connected to a second scan line, and a fourth transistor connected between the second node and a third voltage line and connected to a first scan line.

According to some embodiments, the third voltage line may transfer an initialization voltage, during an initialization period, the first node may be initialized with the initialization voltage through the fourth transistor, and during the initialization period, the second node may be initialized with the initialization voltage through the third transistor and the fourth transistor.

According to some embodiments of the present disclosure, an electronic device includes a display panel including a pixel, a data driving circuit that provides a data signal or a reference voltage to the pixel through a data line, and a scan driving circuit that provides first, second, and third scan signals to the pixel through first, second, and third scan lines. According to some embodiments, the pixel includes a light emitting element connected between a first voltage line a first node, a first transistor connected between the first node and a second voltage line and including a gate electrode connected to a second node, a first capacitor connected between the second node and a third node, a second transistor connected between the data line and the third node, and including a gate electrode connected to the third scan line, a third transistor connected between the first node and the second node, and including a gate electrode connected to the second scan line, and a fourth transistor connected between the second node and a third voltage line, and connected to the first scan line.

According to some embodiments, one frame may include first, second, third, and fourth periods for emitting light of the light emitting element.

According to some embodiments, in the first period, each of the first, second, and third scan signals may be at an active level, and the data line may transfer the reference voltage.

According to some embodiments, in the second period, the first scan signal may be at an inactive level, and each of the second and third scan signals may be at an active level, the data line may transfer the reference voltage, and the first voltage line may transfer a first driving voltage of a first voltage level.

According to some embodiments, in the third period, each of the first and second scan signals may be at an inactive level, and the third scan signal may be at an active level, the data line may transfer the data signal, and the first voltage line may transfer a first driving voltage of a first voltage level.

According to some embodiments, in the fourth period, each of the first, second, and third scan signals may be at an inactive level, and the first voltage line may transfer the first driving voltage of a second voltage level different from the first voltage level.

According to some embodiments, the second voltage level may be greater than the first voltage level.

According to some embodiments, the electronic device may further include a second capacitor connected between the third node and the second voltage line.

### BRIEF DESCRIPTION OF THE DRAWINGS

The above and other aspects and features of some embodiments of the present disclosure will become more apparent by describing in more detail aspects of some embodiments thereof with reference to the accompanying drawings.

FIG. 1 is a block diagram of an electronic device, according to some embodiments.

FIG. 2 is a schematic diagram of electronic devices, according to various embodiments.

FIG. 3 is a block diagram of a display module, according to some embodiments of the present disclosure.

FIG. 4 is a circuit diagram of a pixel, according to some embodiments of the present disclosure.

FIG. 5 is a timing diagram for describing an operation of a pixel, according to some embodiments of the present disclosure.

FIGS. 6A to 6D are drawings for describing an operation of a pixel.

FIG. 7 is a circuit diagram of a pixel, according to some embodiments of the present disclosure.

### DETAILED DESCRIPTION

In the specification, when one component (or area, layer, part, or the like) is referred to as being “on”, “connected to”, or “coupled to” another component, it should be understood that the former may be directly on, connected to, or coupled to the latter, and also may be on, connected to, or coupled to the latter via a third intervening component.

Identical drawing symbols refer to identical components. Also, in drawings, the thickness, ratio, and dimension of components are exaggerated for effectiveness of description of technical contents. The term “and/or” includes one or more combinations of the associated listed items.

The terms “first”, “second”, etc. are used to describe various components, but the components are not limited by the terms. The terms are used only to differentiate one component from another component. For example, a first component may be named as a second component, and vice versa, without departing from the spirit or scope of the present disclosure. A singular form, unless otherwise stated, includes a plural form.

Also, the terms “under”, “beneath”, “on”, “above” are used to describe a relationship between components illustrated in a drawing. The terms are relative and are described with reference to a direction indicated in the drawing.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Unless otherwise defined, all terms (including technical terms and scientific terms) used in this specification have the same meaning as commonly understood by those skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the present disclosure will be described with reference to accompanying drawings.

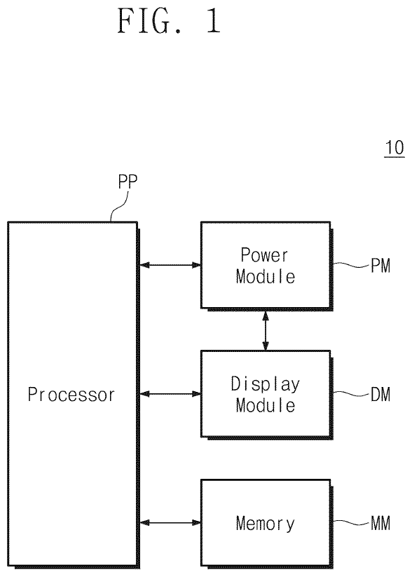

FIG. 1 is a block diagram of an electronic device 10 according to some embodiments.

Referring to FIG. 1, the electronic device 10 according to some embodiments may include a display module DM, a processor PP, a memory MM, and a power module PM.

The processor PP may include at least one of a central processing unit (CPU), an application processor (AP), a graphics processing unit (GPU), a communication processor (CP), an image signal processor (ISP), or a controller.

The memory MM may store data information necessary for operations of the processor PP or the display module DM. When the processor PP executes an application stored in the memory MM, an image data signal and/or an input control signal is transferred to the display module DM, and the display module DM may process the received signal and may output image information through a display screen.

The power module PM may include a power supply module, such as a power adapter or a battery device, and a power conversion module that converts power supplied by the power supply module to generate power required for the operation of the electronic device 10.

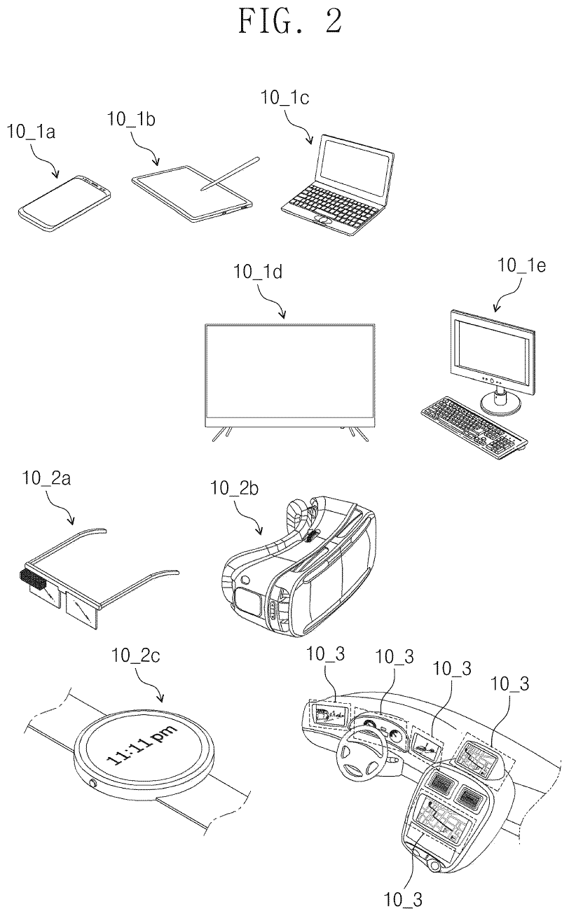

FIG. 2 is a schematic diagram of electronic devices according to various embodiments.

Referring to FIG. 2, various electronic devices according to embodiments may include not only image display electronic devices such as a smart phone 10_1a, a tablet PC 10_1b, a laptop computer 10_1c, a TV 10_1d, a desk monitor 10_1e, but also wearable electronic devices including display modules such as smart glasses 10_2a, a head-mounted display 10_2b, a smart watch 10_2c, etc., and vehicle electronic devices 10_3 including display modules such as a CID (Center Information Display) placed on an instrument panel, a center fascia, or a dashboard of a vehicle, a room mirror display, etc.

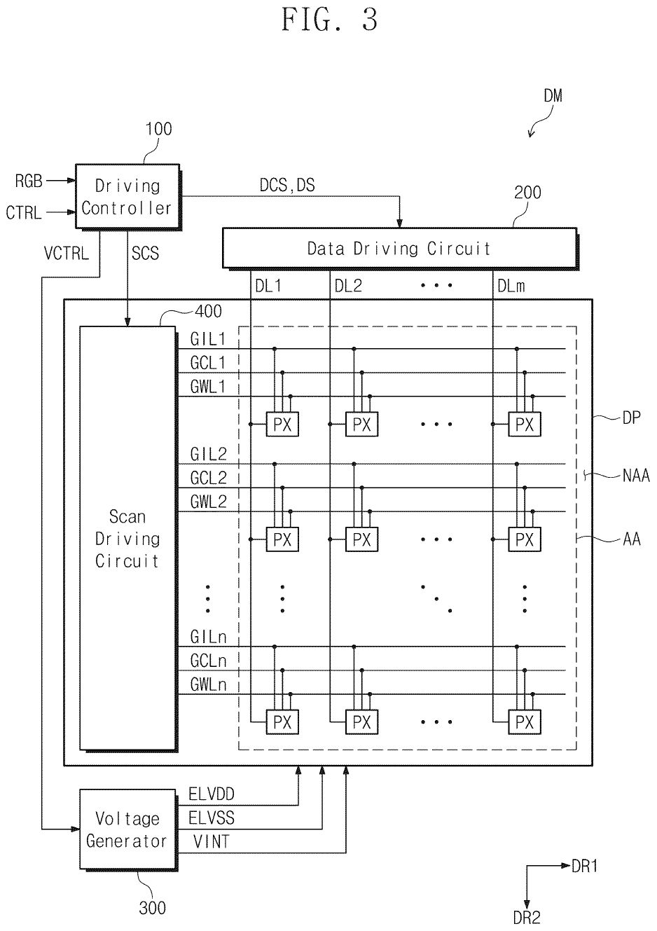

FIG. 3 is a block diagram of the display module DM, according to some embodiments of the present disclosure.

Referring to FIG. 3, the display module DM includes a driving controller 100, a data driving circuit 200, a voltage generator 300, a scan driving circuit 400, and a display panel DP. The driving controller 100, the data driving circuit 200, and the scan driving circuit 400 may be referred to as a driving circuit that provides data signals to pixels PX of the display panel DP.

The driving controller 100 receives an input image signal RGB and a control signal CTRL. According to some embodiments, the input image signal RGB and the control signal CTRL may be provided from the processor PP illustrated in FIG. 1.

The driving controller 100 converts the input image signal RGB into an image data signal DS so as to be output. The driving controller 100 outputs a scan control signal SCS, a data control signal DCS, and a voltage control signal VCTRL. According to some embodiments, the driving controller 100 may output the voltage control signal VCTRL for controlling the voltage generator 300.

The data driving circuit 200 receives the data control signal DCS and the image data signal DS from the driving controller 100. The data driving circuit 200 converts the image data signal DS into data signals and then outputs the data signals to a plurality of data lines DL1 to DLm to be described later. The data signals are analog voltages corresponding to gray scale values of the image data signal DS. According to some embodiments, the data driving circuit 200 may alternately provide the data signal and a reference voltage to data lines DL1 to DLm.

The display panel DP includes first scan lines GIL1, GIL2, . . . , GILn, second scan lines GCL1, GCL2, . . . , GCLn, third scan lines GWL1, GWL2, . . . , GWLn, the data lines DL1 to DLm, and the pixels PX.

The display panel DP may be divided into an effective area AA and a non-effective area NAA. The pixels PX may be located in the effective area AA, and the scan driving circuit 400 may be located in the non-effective area NAA. According to some embodiments, the non-effective area NAA may surround (e.g., in a periphery or outside a footprint of) the effective area AA.

Each of the first scan lines GIL1, GIL2, . . . , GILn, the second scan lines GCL1, GCL2, . . . , GCLn, and third scan lines GWL1, GWL2, . . . , GWLn extends from the scan driving circuit 400 in a first direction DR1, and is arranged to be spaced apart from each other in a second direction DR2. The data lines DL1 to DLm extend from the data driving circuit 200 in the second direction DR2, and are arranged to be spaced apart from each other in the first direction DR1.

The plurality of pixels PX are electrically connected to the first scan lines GIL1, GIL2, . . . , GILn, the second scan lines GCL1, GCL2, . . . , GCLn, the third scan lines GWL1, GWL2, . . . , GWLn, the data lines DL1 to DLm, respectively. For example, the pixels of a first row may be connected to the first scan line GIL1, the second scan line GCL1, and the third scan line GWL1. The pixels of a second row may be connected to the first scan line GIL2, the second scan line GCL2, and the third scan line GWL2. The pixels of an n-th row may be connected to the first scan line GILn, the second scan line GCLn, and the third scan line GWLn.

Each of the plurality of pixels PX may receive a first driving voltage ELVDD, a second driving voltage ELVSS, and an initialization voltage VINT.

The scan driving circuit 400 receives the scan control signal SCS from the driving controller 100. The scan driving circuit 400 may output first scan signals to the first scan lines GIL1, GIL2, . . . , GILn, may output second scan signals to the second scan lines GCL1, GCL2, . . . , GCLn, and may output third scan signals to the third scan lines GWL1, GWL2, . . . , GWLn, in response to the scan control signal SCS. According to some embodiments, the scan driving circuit 400 may include transistors formed through the same process as the pixels PX.

The voltage generator 300 generates voltages necessary for an operation of the display panel DP. According to some embodiments, the voltage generator 300 generates the first driving voltage ELVDD, the second driving voltage ELVSS, and the initialization voltage VINT required for the operation of the display panel DP in response to the voltage control signal VCTRL from the driving controller 100.

The voltage generator 300 may further generate various voltages required for operations of the display panel DP, the driving controller 100, the data driving circuit 200, and the scan driving circuit 400 in addition to the first driving voltage ELVDD, the second driving voltage ELVSS, and the initialization voltage VINT.

Although FIG. 3 illustrates that the voltage generator 300 is located in the display module DM, the present disclosure is not limited thereto. For example, the voltage generator 300 may be located in the power module PM illustrated in FIG. 1.

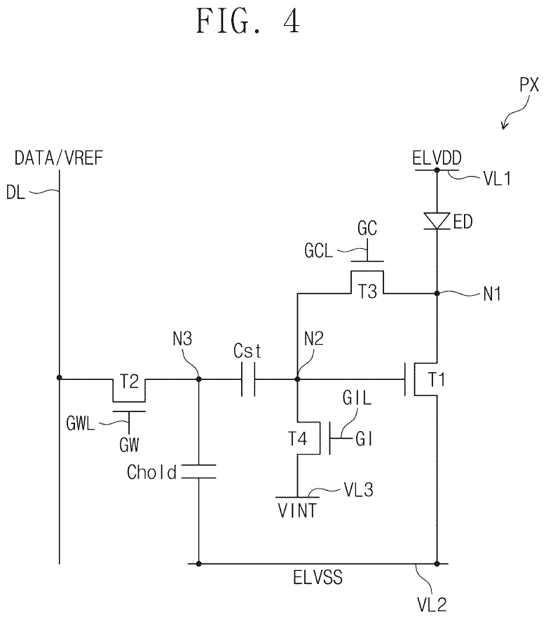

FIG. 4 is a circuit diagram of the pixel PX, according to some embodiments of the present disclosure. Although FIG. 4 illustrates various components in a pixel circuit, embodiments according to the present disclosure are not limited thereto, and according to some embodiments, the pixel circuit may include additional components, or fewer components, without departing from the spirit and scope of embodiments according to the present disclosure.

Each of the plurality of pixels PX illustrated in FIG. 3 may have the same circuit configuration as the pixel PX illustrated in FIG. 4.

The pixel PX illustrated in FIG. 4 is connected to a data line DL, a first scan line GIL, a second scan line GCL, and a third scan line GWL. The data line DL may be any one of the data lines DL1 to DLm illustrated in FIG. 3. The first scan line GIL, the second scan line GCL, and the third scan line GWL may be any one of the first scan lines GIL1, GIL2, . . . , GILn), the second scan lines GCL1, GCL2, . . . , GCLn, and the third scan lines GWL1, GWL2, . . . , GWLn illustrated in FIG. 3, respectively.

Referring to FIG. 4, the pixel PX includes a light emitting element ED, first, second, third, and fourth transistors T1, T2, T3, and T4, a first capacitor Cst, and a second capacitor Chold.

According to some embodiments, each of the first to fourth transistors T1 to T4 is an N-type transistor having an oxide semiconductor as a semiconductor layer. However, the present disclosure is not limited thereto, and each of the first to fourth transistors T1 to T4 may be a P-type transistor having a low-temperature polycrystalline silicon (LTPS) semiconductor layer. According to some embodiments, at least one of the first to fourth transistors T1 to T4 may be an N-type transistor, and the rest may be P-type transistors. In addition, the circuit configuration of the pixel according to the present disclosure is not limited to FIG. 4. The pixel PX illustrated in FIG. 4 is only an example, and the circuit configuration of the pixel PX may be modified and implemented.

Referring to FIG. 4, the first scan line GIL may transfer a first scan signal GI, the second scan line GCL may transfer a second scan signal GC, and the third scan line GWL may transfer a third scan signal GW. The data line DL transfers a data signal DATA or a reference voltage VREF. The data signal DATA may have a voltage level corresponding to the input image signal RGB input to the display module DM (refer to FIG. 3). The reference voltage VREF may have a voltage level for initializing a third node N3.

A first voltage line VL1, a second voltage line VL2, and a third voltage line VL3 may transfer the first driving voltage ELVDD, the second driving voltage ELVSS, and the initialization voltage VINT, respectively, to the pixel PX.

The light emitting element ED is connected between the first voltage line VL1 and a first node N1.

The first transistor T1 is connected between the first node N1 and the second voltage line VL2 and includes a gate electrode connected to a second node N2.

The second transistor T2 is connected between the data line DL and the third node N3 and includes a gate electrode connected to the third scan line GWL.

The third transistor T3 is connected between the first node N1 and the second node N2 and includes a gate electrode connected to the second scan line GCL.

The fourth transistor T4 is connected between the second node N2 and the third voltage line VL3 and includes a gate electrode connected to the first scan line GIL.

The first capacitor Cst is connected between the second node N2 and the third node N3. The second capacitor Chold may be connected between the third node N3 and the second voltage line VL2.

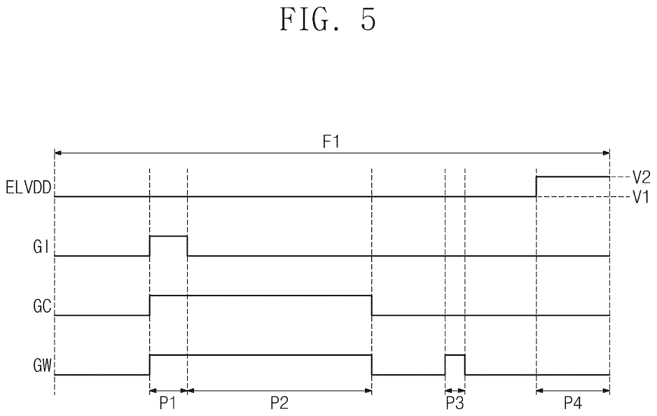

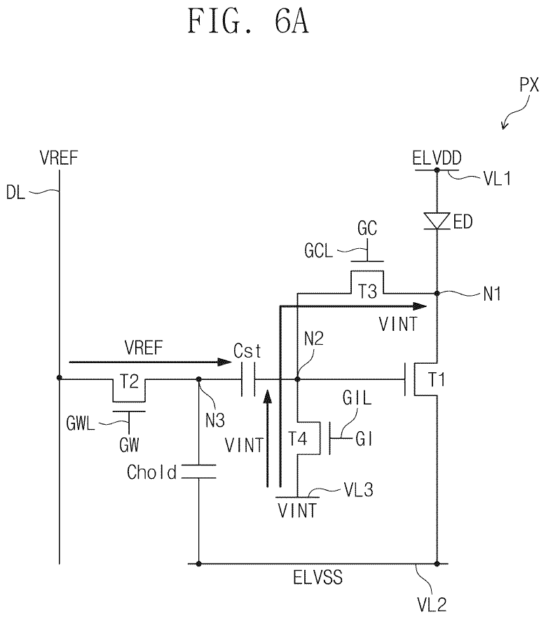

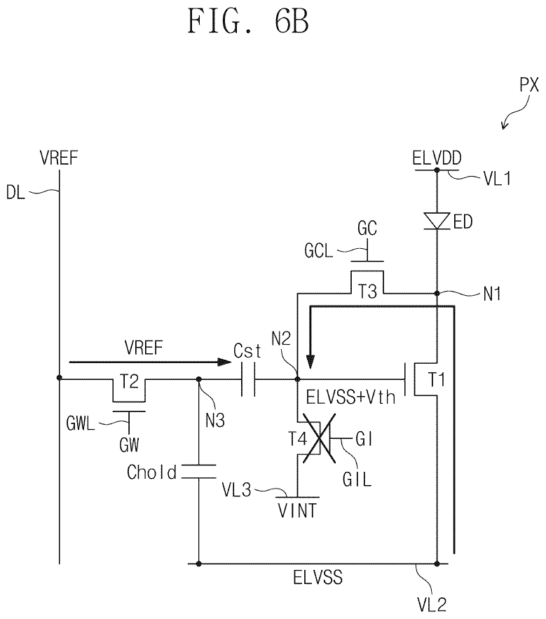

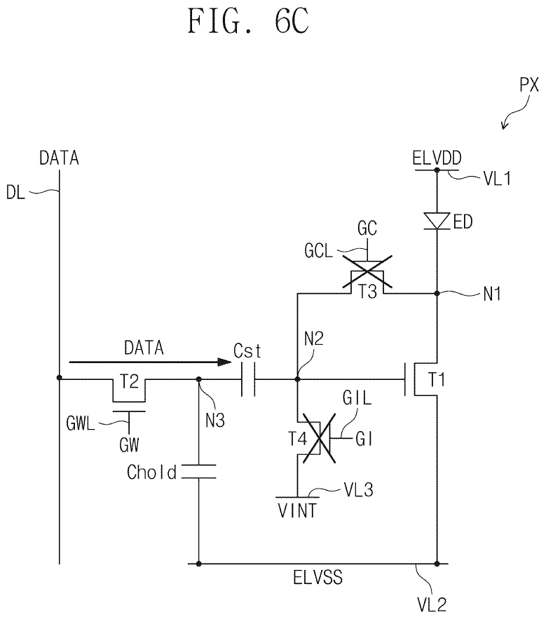

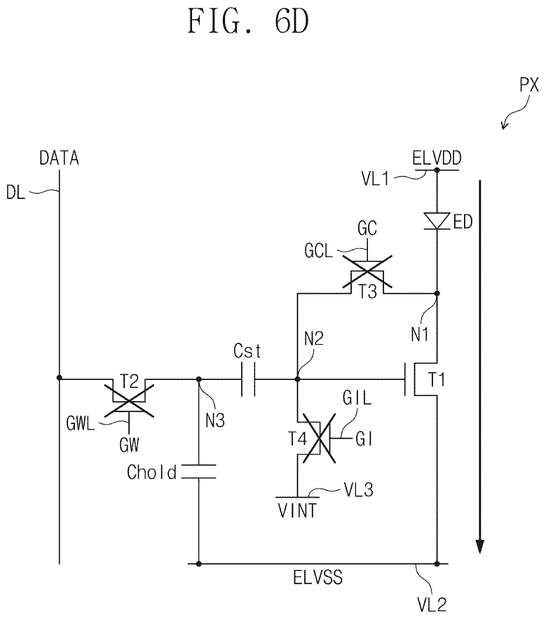

FIG. 5 is a timing diagram for describing an operation of the pixel PX, according to some embodiments of the present disclosure. FIGS. 6A to 6D are drawings for describing the operation of the pixel PX.

The waveforms of each of the first scan signal GI, the second scan signal GC, and the third scan signal GW and the voltage level of the first driving voltage ELVDD illustrated in FIG. 5 are merely examples, and the present disclosure is not limited thereto.

Referring to FIGS. 5 and 6A to 6D, one frame F1 includes a first period P1, a second period P2, a third period P3, and a fourth period P4 for emitting light of the light emitting element ED. According to some embodiments, the first period P1, the second period P2, the third period P3, and the fourth period P4 may be sequential in time.

According to some embodiments, data signals may be provided to the pixels PX of a row of the display panel DP illustrated in FIG. 3 through the data lines DL1 to DLm during one frame F1.

Referring to FIGS. 5 and 6A, during the first period P1, the first, second, and third scan signals GI, GC, and GW are all at an active level (e.g., a high level). During the first period P1, the first driving voltage ELVDD has a first voltage level V1.

When the first, second, and third scan signals GI, GC, and GW are all at an active level, the second, third, and fourth transistors T2, T3, and T4 are all turned on.

During the first period P1, the reference voltage VREF may be provided to the data line DL. Therefore, the reference voltage VREF is transferred to a first electrode of the capacitor Cst, i.e., the third node N3 through the second transistor T2.

During the first period P1, the initialization voltage VINT is transferred to a second electrode of the capacitor Cst, i.e., the second node N2 through the fourth transistor T4, and the initialization voltage VINT is transferred to a first electrode of the first transistor T1, i.e., the first node N1 through the third and fourth transistors T3 and T4. That is, during the first period P1, the gate electrode of the first transistor T1 and the first electrode of the first transistor T1 may be initialized with the initialization voltage VINT.

The first period P1 may be an initialization period in which the gate electrode of the first transistor T1 and the first electrode of the first transistor T1 are initialized with the initialization voltage VINT.

Referring to FIG. 5 and FIG. 6B, during the second period P2, the second and third scan signals GC and GW are at an active level (e.g., a high level), and the first scan signal GI is at an inactive level (e.g., a low level). During the second period P2, the first driving voltage ELVDD has the first voltage level V1.

When the second and third scan signals GC and GW are at an active level, the second and third transistors T2 and T3 are maintained in a turned-on state. Because the first scan signal GI is at an inactive level, the fourth transistor T4 is turned off.

During the second period P2, the reference voltage VREF may be provided to the data line DL. The first electrode of the capacitor Cst, i.e., the third node N3, may be maintained at the reference voltage VREF.

During the second period P2, the second driving voltage ELVSS may be transferred to the second electrode of the capacitor Cst, i.e., the second node N2 through the first and third transistors T1 and T3. In this case, the voltage of the second node N2 may be a voltage ELVSS+Vth higher than the second driving voltage ELVSS by a threshold voltage Vth of the first transistor T1.

The second period P2 may be a compensation period for compensating the threshold voltage Vth of the first transistor T1.

Referring to FIG. 5 and FIG. 6C, during the third period P3, the third scan signal GW is at an active level (e.g., a high level), and the first and second scan signals GI and GC are at an inactive level (e.g., a low level). During the third period P3, the first driving voltage ELVDD has the first voltage level V1.

When the first and second scan signals GI and GC are at an inactive level, the third and fourth transistors T3 and T4 are turned off.

Because the third scan signal GW is at an active level, the second transistor T2 is turned on. In this case, the data signal DATA may be provided to the data line DL. The voltage level of the first electrode of the first capacitor Cst, i.e., the third node N3, changes from the reference voltage VREF to the data signal DATA.

The voltage level of the second electrode of the first capacitor Cst, i.e., the second node N2, increases by the difference between the data signal DATA and the reference voltage VREF in the voltage ELVSS+Vth of the second period P2. That is, the voltage level of the second electrode of the first capacitor Cst is changed to ELVSS+Vth+(DATA−VREF).

The third period P3 may be a write period in which the data signal DATA is transferred to the first electrode of the first capacitor Cst.

Referring to FIGS. 5 and 6D, during the fourth period P4, the first, second, and third scan signals GI, GC, and GW are all at an inactive level (e.g., a low level).

The signal provided to the data line DL in the fourth period P4 may be the same data signal DATA as in the third period P3.

When the first, second, and third scan signals GI, GC, and GW are all at an inactive level, the second, third, and fourth transistors T2, T3, and T4 are all turned off.

During the fourth period P4, the first driving voltage ELVDD has a second voltage level V2 different from the first voltage level V1. According to some embodiments, the second voltage level V2 is greater than the first voltage level V1. According to some embodiments, the second voltage level V2 of the first driving voltage ELVDD may have a voltage level greater than the second driving voltage ELVSS.

As the first driving voltage ELVDD changes from the first voltage level V1 to the second voltage level V2, a current path may be formed between the first voltage line VL1 and the second voltage line VL2 through the light emitting element ED and the first transistor T1.

The voltage level of the second electrode of the first capacitor Cst, i.e., the gate electrode of the first transistor T1, is ELVSS+Vth+(DATA−VREF), and the voltage of the second electrode (e.g., the source electrode) of the first transistor T1 is the second driving voltage ELVSS.

A driving current (referred to as an “Ids”) flowing through the first transistor T1 may be proportional to the difference (referred to as Vgs) between the gate voltage and the source voltage of the first transistor T1.

The driving current Ids of the first transistor T1 may be calculated by Equation 1.

### Equation 1

Ids=k(Vgs−Vth)²

=k[(ELVSS+Vth+DATA−VREF−ELVSS)−Vth)²

=k(DATA−VREF)²

Here, Vgs is the difference between the gate voltage and the source voltage of the first transistor T1, Vth is the threshold voltage of the first transistor T1, and “k” is a constant.

As may be seen in Equation 1, the driving current Ids flowing through the first transistor T1 is proportional to the difference between the data signal DATA and the reference voltage VREF.

When the reference voltage VREF is maintained at a uniform voltage level, the driving current Ids flowing through the first transistor T1 is proportional to the data signal DATA. Therefore, the brightness of the light emitting element ED may be determined depending on the voltage level of the data signal DATA.

The fourth period P4 may be a light emitting period in which the light emitting element ED emits light.

The pixel PX may generate a driving current required for the light emitting element ED by including four transistors, i.e., the first to fourth transistors T1 to T4 and one capacitor, i.e., the first capacitor Cst.

In this way, because the pixel PX includes a minimum number of components, the circuit area of the pixel PX may be minimized. Therefore, a greater number of pixels PX may be arranged per unit area. Therefore, the display quality of an image displayed on the electronic device 10 (refer to FIG. 1) may be relatively improved.

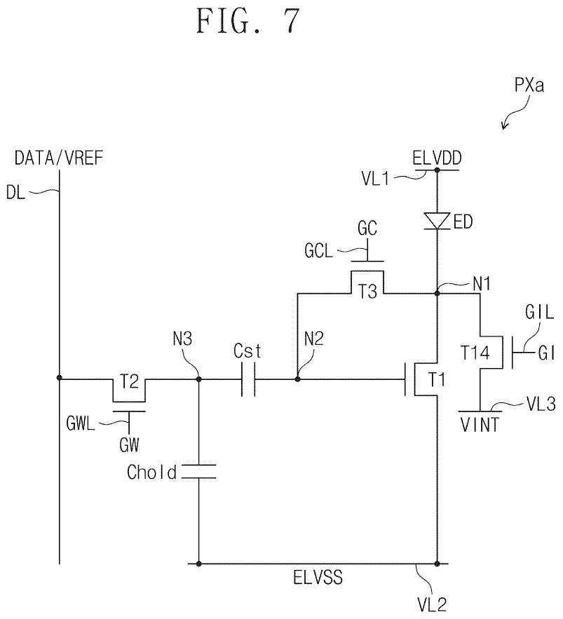

FIG. 7 is a circuit diagram of a pixel PXa, according to some embodiments of the present disclosure. Although FIG. 7 illustrates various components in a pixel circuit, embodiments according to the present disclosure are not limited thereto, and according to some embodiments, the pixel circuit may include additional components, or fewer components, without departing from the spirit and scope of embodiments according to the present disclosure.

Each of the plurality of pixels PX illustrated in FIG. 3 may have the same circuit configuration as the pixel PXa illustrated in FIG. 7.

The pixel PXa illustrated in FIG. 7 may have a circuit configuration similar to that of the pixel PX illustrated in FIG. 3. In the pixel PXa illustrated in FIG. 7, the same reference symbols are used for the same components as those of the pixel PX illustrated in FIG. 3, and additional descriptions are omitted to avoid redundancy.

Referring to FIG. 7, the pixel PXa includes the light emitting element ED, first, second, third, and fourteenth transistors T1, T2, T3, and T14, the first capacitor Cst, and the second capacitor Chold.

The fourteenth transistor T14 is connected between the first node N1 and the third voltage line VL3 and includes a gate electrode connected to the first scan line GIL.

Referring to FIGS. 5 and 7, during the first period P1, the first, second, and third scan signals GI, GC, and GW are all at an active level (e.g., a high level). During the first period P1, the first driving voltage ELVDD has a first voltage level V1.

When the first, second, and third scan signals GI, GC, and GW are all at an active level, the second, third, and fourteenth transistors T2, T3, and T14 are all turned on.

During the first period P1, the reference voltage VREF may be provided to the data line DL. Therefore, the reference voltage VREF is transferred to a first electrode of the capacitor Cst, i.e., the third node N3 through the second transistor T2.

During the first period P1, the initialization voltage VINT is transferred to the first electrode of the first transistor T1, i.e., the first node N1 through the fourteenth transistor T14. In addition, during the first period P1, the initialization voltage VINT is transferred to the second electrode of the capacitor Cst, i.e., the second node N2, through the third and fourteenth transistors T3 and T14. That is, during the first period P1, the gate electrode of the first transistor T1 and the first electrode may be initialized with the initialization voltage VINT.

The first period P1 may be an initialization period in which the gate electrode of the first transistor T1 and the first electrode of the first transistor T1 are initialized with the initialization voltage VINT.

Because the operation of the second, third, and fourth periods P2, P3, and P4 of the pixel PXa is the same as the operation of the pixel PX described with reference to FIGS. 6B, 6C and 6D, an additional description is omitted to avoid redundancy.

According to some embodiments of the present disclosure, the pixel with the above configurations may emit light with a minimum number of elements. Accordingly, a larger number of pixels may be arranged per unit area. Therefore, the display quality of the image displayed on the electronic device may be relatively improved.

Although aspects of some embodiments of the present disclosure have been described above with reference to embodiments thereof, it will be understood by those skilled in the art or having ordinary knowledge in the art that various modifications and substitutions are possible, without departing from the spirit and the technical scope of embodiments according to the present disclosure as set forth in the claims below, and their equivalents. Accordingly, the technical scope of the present disclosure is not limited to the detailed description of this specification, but should be defined by the claims, and their equivalents.

What is claimed is:

1. A pixel comprising:
a light emitting element connected between a first voltage line and a first node;
a first transistor connected between the first node and a second voltage line and including a gate electrode connected to a second node;
a first capacitor connected between the second node and a third node;
a second transistor connected between a data line and the third node;
a third transistor connected between the first node and the second node; and
a fourth transistor connected between the second node and a third voltage line.

2. The pixel of claim 1, wherein the second transistor includes a gate electrode connected to a third scan line,
wherein the third transistor includes a gate electrode connected to a second scan line, and
wherein the fourth transistor includes a gate electrode connected to a first scan line.

3. The pixel of claim 2, wherein the first, second, and third scan lines are configured to transfer first, second, and third scan signals, respectively.

4. The pixel of claim 3, wherein one frame includes first, second, third, and fourth periods for emitting light of the light emitting element.

5. The pixel of claim 4, wherein in the first period, each of the first, second and third scan signals is at an active level, and
wherein the data line transfers a reference voltage.

6. The pixel of claim 4, wherein in the second period, the first scan signal is at an inactive level, and each of the second and third scan signals is at an active level,
wherein the data line is configured to transfer a reference voltage, and
wherein the first voltage line is configured to transfer a first driving voltage of a first voltage level.

7. The pixel of claim 4, wherein in the third period, each of the first and second scan signals is at an inactive level, and the third scan signal is at an active level,
wherein the data line is configured to transfer a data signal, and
wherein the first voltage line is configured to transfer a first driving voltage of a first voltage level.

8. The pixel of claim 7, wherein in the fourth period, each of the first, second and third scan signals is at an inactive level, and
wherein the first voltage line is configured to transfer the first driving voltage of a second voltage level different from the first voltage level.

9. The pixel of claim 8, wherein the second voltage level is greater than the first voltage level.

10. The pixel of claim 1, further comprising:
a second capacitor connected between the third node and the second voltage line.

11. A pixel comprising:
a light emitting element connected between a first voltage line and a first node;
a first transistor connected between the first node and a second voltage line and including a gate electrode connected to a second node;
a first capacitor connected between the second node and a third node;
a second transistor connected between a data line and the third node and connected to a third scan line;
a third transistor connected between the first node and the second node and connected to a second scan line; and
a fourth transistor connected between the second node and a third voltage line and connected to a first scan line.

12. The pixel of claim 11, wherein the third voltage line is configured to transfer an initialization voltage,
wherein during an initialization period, the first node is initialized with the initialization voltage through the fourth transistor, and
wherein during the initialization period, the second node is initialized with the initialization voltage through the third transistor and the fourth transistor.

13. An electronic device comprising:
a display panel including a pixel;
a data driving circuit configured to provide a data signal or a reference voltage to the pixel through a data line; and
a scan driving circuit configured to provide first, second, and third scan signals to the pixel through first, second, and third scan lines, and
wherein the pixel includes:
a light emitting element connected between a first voltage line a first node;
a first transistor connected between the first node and a second voltage line and including a gate electrode connected to a second node;
a first capacitor connected between the second node and a third node;
a second transistor connected between the data line and the third node, and including a gate electrode connected to the third scan line;
a third transistor connected between the first node and the second node, and including a gate electrode connected to the second scan line; and
a fourth transistor connected between the second node and a third voltage line, and connected to the first scan line.

14. The electronic device of claim 13, wherein one frame includes first, second, third, and fourth periods for emitting light of the light emitting element.

15. The electronic device of claim 14, wherein in the first period, each of the first, second, and third scan signals is at an active level, and
wherein the data line is configured to transfer the reference voltage.

16. The electronic device of claim 14, wherein in the second period, the first scan signal is at an inactive level, and each of the second and third scan signals is at an active level,
wherein the data line is configured to transfer the reference voltage, and
wherein the first voltage line is configured to transfer a first driving voltage of a first voltage level.

17. The electronic device of claim 14, wherein in the third period, each of the first and second scan signals is at an inactive level, and the third scan signal is at an active level,
wherein the data line is configured to transfer the data signal, and
wherein the first voltage line is configured to transfer a first driving voltage of a first voltage level.

18. The electronic device of claim 17, wherein in the fourth period, each of the first, second, and third scan signals is at an inactive level, and
wherein the first voltage line is configured to transfer the first driving voltage of a second voltage level different from the first voltage level.

19. The electronic device of claim 18, wherein the second voltage level is greater than the first voltage level.

20. The electronic device of claim 13, further comprising:
a second capacitor connected between the third node and the second voltage line.
